(19) United States
(12) Patent Application Publication
(10) Pub. No.: US 2014/0279267 A1
(43) Pub. Date: Sep. 18, 2014

(54) Methods and apparatus for aggregating, displaying, and promoting branded commodities from multiple vendors

(71) Applicant: Hermann P. Calabria, Seattle, WA (US)

(72) Inventor: Hermann P. Calabria, Seattle, WA (US)

(73) Assignee: DIAMOND REVIEW, INC., Seattle, WA (US)

(21) Appl. No.: 14/192,252

(22) Filed: Feb. 27, 2014

Related U.S. Application Data
(60) Provisional application No. 61/799,721, filed on Mar. 15, 2013.

(51) Int. Cl. G06Q 30/06

(52) U.S. Cl. CPC G06Q 30/0629
USPC 705/26.64

(57) ABSTRACT

The present invention is related to receiving, storing, and displaying commodities, and more particularly to promoting branded commodities within a commodity search engine which may contain a great number of unbranded and branded commodities.

### CROSS-REFERENCE TO RELATED APPLICATIONS

This patent application claims priority to U.S. Provisional Patent Application No. 61/799,721, filed Mar. 15, 2013, entitled “Methods and apparatus for aggregating, displaying, and promoting branded commodities from multiple vendors”, which is incorporated herein by reference.

### FEDERALLY SPONSORED RESEARCH

None

### SEQUENCE LISTING

None

### FIELD OF THE INVENTION

The present invention is related to receiving, storing, and displaying commodities, and more particularly to promoting branded commodities within a commodity search engine which may contain a great number of unbranded and branded commodities.

### BACKGROUND

A number of websites exist today that allow customers to search for commodities for purchase. For example, many gemstone vendors such as Blue Nile™ and Union Diamond™ offer gemstone search engines that allow customers to search for gemstones for purchase from these respective vendors exclusively.

There are a few consumer-centric portals such as DiamondReview.com™ and Pricescope™, which offer gemstone search engines that allow customers to simultaneously search for gemstones from multiple vendors (as opposed to the single-vendor search engines previously described). Customers tend to prefer these search engines, because they allow for convenient comparison-shopping of many different gemstones from many different vendors.

The number of commodities (such as gemstones) available on multi-vendor search engines is quite large, often representing the entire global market of available commodities. For all the benefit of having a large selection, customers sometimes get overwhelmed, because it is sometimes difficult to find a high-quality commodity within the large selection, or in selecting “the one” of the many high-quality commodities available (the proverbial “diamond in the rough”). Therefore, there is a need for methods and apparatus that assists customers in finding high-quality commodities in a multi-vendor commodity search engine.

### SUMMARY OF THE INVENTION

Methods and apparatus for aggregating, displaying, and promoting branded commodities from multiple vendors are presented. A multi-vendor commodity search engine server is presented which enables users to perform searches through a user client. The server can be configured by the user to return unbranded and branded commodities, or to only return branded commodities. The server can be configured to present options for branded commodity programs in a tiered and ranked manner, and the user client interface is automatically updated to reflect the most recent configuration. The presented methods and apparatus also include a feed engine to obtain data about commodities from vendor servers. The presented methods and apparatus also include a ranking engine to reconfigure tier & rank of branded commodity programs, responsive to bid data entered by vendor agents.

### BRIEF DESCRIPTIONS OF THE DRAWINGS

FIG. 1. is a diagram of the overall system in context of a global computer network

FIG. 2. is a diagram of the overall system showing the relative configuration of the feed engine, the ranking engine, the search engine, and the databases for vendors, commodities, and branded commodity programs, relative to user clients, vendor servers, and vendor agents.

FIG. 3. is a table showing an exemplary Vendors database

FIG. 4. is a table showing an exemplary Commodities database

FIG. 5. is a table showing an exemplary Branded Commodity Programs database

FIG. 6. is a flow chart of the initialization sequence between user client and multi-vendor commodity search engine server

FIG. 7. is a flow chart of the search engine

FIG. 8. is a flow chart of the feed engine

FIG. 9. is a flow chart of the ranking engine

FIG. 10. is a screen shot of an exemplary user client screen, showing an exemplary search input form, and an exemplary search results

FIG. 11. is a screen shot of an exemplary user client screen, showing an exemplary search input form in detail

FIG. 12. is a screen shot of an exemplary user client screen, showing an exemplary search results in detail

FIG. 13. is a screen shot of an exemplary user client screen, showing an exemplary search results in detail, and showing only branded commodities

FIG. 14. is a diagram of an exemplary global network that employs embodiments of the present invention

FIG. 15. is a diagram of an exemplary computer that enacts and enables the embodiments of the present invention

### DETAILED DESCRIPTION OF THE INVENTION

An overview of the method and apparatus for aggregating, displaying, and promoting branded commodities from multiple vendors is shown in FIG. 1. A plurality of user clients 1 connect through a global network (such as the Internet) 3 to a multi-vendor commodity search engine server 2. The user clients can be internet browsers (such as Microsoft Internet Explorer™ or Google Chrome™) operating within a desktop environment (such as the Microsoft Windows™ operating system) or within a mobile environment (such as the Apple iPhone™). The user clients can also be software apps (such as those obtained from the Apple App Store™), or any other software running on a computer that is connected to a global network 3 that can be networked and connected to the server 2.

Connected to the global network 3 are also a plurality of exemplary vendor servers 4, 5, and 6. The multi-vendor commodity search engine server 2 periodically makes requests from 4, 5, and 6 to obtain updated information about commodities that the vendors have for sale.

An exemplary global computer network is shown in FIG. 14. A detailed exemplary computer is shown in FIG. 15 In the present embodiment, the global network 3 is implemented as shown in FIG. 14. In the present embodiment, the exemplary computer shown in FIG. 15 is configured to operate as a multi-vendor commodity search engine server 2. In the present embodiment, other exemplary computers shown in FIG. 15 are configured to operate as user clients 1. In the present embodiment, other exemplary computers shown in FIG. 15 are configured to operate as vendor servers 4, 5, and 6. The steps required to implement such configurations are well-known to anyone skilled in the art.

FIG. 2. shows the multi-vendor commodity search engine server 2, along with vendor servers 4, 5, 6, and the user clients 1. The global network 3 is not shown, but is implied as the preferred method of interconnecting the components as shown in FIG. 1. In the present embodiment, the multi-vendor commodity search engine server 2 is implemented as a “Lamp” stack. “Lamp” stands for Linux, Apache, MySQL, Perl/PHP. The feed engine 10, ranking engine 11, and search engine 15 are implemented in Perl which in turn runs within the Apache/Linux framework. The vendors database 12, commodities database 13, and branded commodity programs database 14 are tables implemented within a MySQL database, which in turn runs on the Linux operating system. The interconnections are made using DBI. The foregoing represent the present embodiments, and it will be obvious to anyone skilled in the art that the present invention may be implemented on any number of different software and hardware configurations, including but not limited to software equivalents made by Microsoft Corporation (such as ASP, MSSQL, ITS, and Windows Server).

The multi-vendor commodity search engine server 2 as shown in FIG. 2 contains a feed engine 10, a ranking engine 11, a vendors database 12, a commodities database 13, a branded commodity programs database 14, and a search engine 15. The feed engine 10 is configured to obtain commodity information from vendors 4, 5, 6. The feed engine 10 uses information obtained from Vendors database 12 to identify the exemplary vendor servers 4, 5, and 6, and to periodically schedule updates of commodity information, which are then stored in Commodities database 13.

The feed engine 10 is responsible for maintaining an up-to-date Commodities database 13. The search engine 15 uses the Commodities database to perform searches on demand from user clients 1. The communication between the user clients 1 and the search engine 16 can be accomplished through many different networking protocols. The present embodiment uses the hypertext protocol (http) and an ajax framework which in turn uses JSON as the data exchange format.

FIG. 3. shows exemplary data 16 as might be present on a vendors database 12. The data consists of a vendor_id column 17, a company_name column 18, a last_feed column 19, and a feed_config column 20, among other columns that might be desirable or convenient. The example shown on FIG. 3 contains sample rows 21-25. The vendor_id column 17 is used to uniquely identify each vendor that is known to the system 2. The company_name column 18 is used to identify each vendor by name. The last_feed column 19 is used to record the date of the last update of the commodity information from each particular vendor. By comparison 19 to the present date, the feed engine 10 is able to determine when an update to the commodity information should be made. The feed_config column 20 is used to customize the feed engine 10 to each vendor server 4, 5, and 6. For example, vendor server 4 may provide data using the http protocol, whereas vendor server 5 uses the ftp protocol. This information (including access information such as vendor server 5's username/password) is stored as an object in the feed_config column 20. The vendor database 12 can store any number of vendors, as shown by exemplary data row 25.

FIG. 4. shows exemplary data 26 as might be present on a commodities database 13. The data consists of a comm_id column 27, a vendor_id column 28, a branded_id column 29, a vendor_ref column 30, and a comm_description column 31, among other columns that might be desirable or convenient. The comm_id column 27 uniquely identifies each commodity contained in the commodities database 13. In the present embodiment, the commodities are diamonds, so each diamond would be represented by one row and one unique comm_id. The vendor_id column 28 identifies the vendor of the commodity, and matches the vendor_id column in the vendors database 12, as represented by 17 in FIG. 3. The branded_id column 29 identifies the commodity of being within a branded commodity program, and matches the branded_id column in the branded commodity programs database 14, as represented by 43 in FIG. 5. The vendor_ref column 30 is a reference id provided by the vendor, for the specific commodity. Since different vendors may use similar or overlapping numbering schemes, the system 2 does not rely on vendor_ref column 30 to uniquely identify each commodity, but instead relies on comm_id column 27 as previously discussed. The comm_description column 31 is used to further describe the commodity. In the present embodiment, the comm_description column 31 is actually a set of additional columns that describes the shape, carat weight, color, and other properties of each diamond. However, it will be understood by one skilled in the art that the comm_description column 31 can comprise of other parameters used to describe other types of commodities. The commodities database 13 can store any number of commodities, as shown by exemplary data row 41. The commodities database 13 can store unbranded and branded commodities together. The exemplary data 26 shows exemplary rows 32, 33, 35, 36, 37, and 41, all bearing a branded_id value of 0. In the present embodiment, a branded_id value of 0 means that the commodity is unbranded. Conversely, exemplary row 34 contains a branded commodity, bearing a branded_id value of 1 and implying a first branded commodity program. Exemplary rows 38, 39, and 40 contains additional branded commodities, bearing a branded_id value of 2 and implying a second branded commodity program.

FIG. 5. shows exemplary data 42 as might be present on a branded commodity program database 14. The data consists of a branded_id column 43, a vendor_id column 44, a tier&rank column 45, a name column 46, and a bid column 47, among other columns that might be desirable or convenient. The branded_id column 43 uniquely identifies each branded commodity program. In the present embodiment, the commodities are diamonds, so each branded commodity program might be a unique collection of diamonds offered by a particular vendor, such as Blue Nile's “Signature” collection. The vendor_id column 44 uniquely identifies the vendor associated with the given branded commodity program, such as Blue Nile in the previous example. The tier & rank column 45 specifies where in the search engine form 64 (FIG. 10) the given branded commodity program should appear. This is an important aspect of the present invention, because vendors will be willing to compete for higher tiers & ranks, and will be discussed in more detail later in this writing. The name column 46 identifies the branded commodity program by name. The bid column 47 stores information about each vendor's bid (i.e. willingness to pay) to promote the branded commodity program by achieving a higher tier & rank. The branded commodity program database 14 can store any number of vendors, as shown by exemplary data row 50.

Before the user can begin using the system 2, it is desirable to undergo an initialization sequence between the user client 1 and the system 2. A flow chart for such an exemplary initialization sequence is shown in FIG. 6. Step 80, the user's client requests initial parameters from the multi-vendor commodity search engine server 2, and more specifically to the search engine 15 within server 2. Step 81, the server 2 responds with initial parameters, including branded commodity program configuration information. Such information may include branded_id, tier & rank information, logos associated with the branded commodity program, and other related information. Additionally, such initial parameters may include other information used for initializing the search request form 64 (FIG. 11) located within the user client 1. In the present embodiment, additional initial information includes available gemological labs, available diamond shapes, the and the total number of diamonds available in the commodities database 13. In the present embodiment, the initialization sequence occurs by an ajax call from client to server. The client requests initial parameters, the server responds with a JSON-formatted object which contains all of the initial parameters, and the client populates the information into the search form 64 before allowing the user to submit a search request. It will be known by those skilled in the art that the initialization sequence may occur in many different ways, including by providing a fully pre-populated form (in HTML form) to the client upon the user navigating to the web page that implements the user interface for accessing the server 2.

FIG. 11 shows an exemplary search request form 64, which is located and implemented within the user client 1, and which is shown in FIG. 11 after initialization. The user enters the parameters 72 for a search of a requested commodity, and initiates the search. The present embodiment allows users to search for diamonds, so search parameters include a Carat Weight range, a Color range, a Clarity range, a Cut range, a Depth % range, a Table % range, a Fluorescence range, a Price range, and a Labs selection. The choice of search parameters is unlimited, and it will be understood that each embodiment of the present invention may have a wide variety of different parameters applicable to the underlying commodities. In addition to the parameters 72, the user is presented with branded commodity program filters 68 and 69. The contents, position, location, and availability of branded commodity program filters 68 and 69 is controlled by the previously disclosed initialization sequence (with reference to FIG. 6). In the exemplary search request form 64, “tier 1” programs 68 appear above “tier 2” programs 69. Furthermore, there is a toggle button 70 that allows the user to control whether the “tier 2” programs are shown above. The exemplary form 64 is shown in two different states in FIG. 10 (with “tier 2” invisible), and in FIG. 11 (with “tier 2” visible). The toggle button 70 is an important distinction of the present invention, because it makes the form 64 less cluttered/confusing for the user, while making “tier 1” programs much more valuable to vendors than “tier 2” program.

FIG. 7 shows an exemplary flow chart of a search sequence that occurs within the search engine 15 when the user initiates a search. In step 51, the search engine 15 receives a search request. In the present embodiment, such a request is received by the server 2 via an ajax call that contains the search parameters that the user set in the search form 64, and the server 2 then passes the request to search engine 15. In step 52, the search engine 15 builds a SQL query to limit the search results to the requested search parameters (criteria). In step 53, if at least one branded commodity program has been selected, then the SQL query is further amended to include only the commodities that match the selected branded commodity program. In optional step 54, the SQL query is further amended such that the results are optionally ordered from data from the branded commodity program database 14. The present embodiment does not perform such ordering, but it should be understood that it might be a desirable feature for other embodiments, and that doing so would be within the scope of the present invention. In step 55, the SQL query is executed. Although the present embodiment generates the results in a single SQL query, it should be noted that the similar results could be obtained by generating multiple SQL queries, or by a combination of SQL queries and further processing. All of the foregoing are within the scope of the present invention, as they would be obvious to anyone skilled in the art. In step 56, the results are formatted and sent to the user's client. In the present embodiment, step 56 is implemented by responding to the initial http query (which occurs in step 51) with a JSON-formatted response object that contains the search results.

FIG. 12. shows an exemplary search results 65, as may be displayed on the screen of a user client 1. The present embodiment is designed for diamonds, so search results 65 comprise of a number of rows (such as 74) with commodity data related to diamonds, such as Shape, Carat Weight, Color, etc. Column 73 shows a logo of the vendor of each diamond. Each row (such as 74) can be hyperlinked to the vendor's web site, and specifically to the page on the vendor's web site that describes the commodity in detail, allows the user to purchase the commodity, etc. Branded commodities are indicated by branded commodity icon 76. Each branded commodity program can designate such an icon to be displayed within the exemplary search results 65 every time a commodity is within a given branded commodity program. As an example, row 74 is an unbranded commodity because it does not contain a branded commodity icon. Row 75 is a branded commodity, because it does contain a branded commodity icon.

FIG. 13. shows an exemplary search request form 84. In this search request form, two branded commodity programs 77 have been selected (notice the checked checkbox), and two different branded commodity programs 78 have not been selected (notice the unchecked checkbox). In this example, step 53 of the search process limits search results only to the branded commodity programs that were selected (77). Exemplary search results 85 show that only commodities associated with “Julia's Hearts” and “Star Signature” (rows 79) have been selected as search results.

FIG. 8. shows an exemplary flow chart for the operation of feed engine 10. On a periodic basis, the feed engine 10 iterates through all vendors to determine whether it is time to perform a feed operation 57. For each vendor, the feed file is fetched from the vendor server 4, 5, or 6 as shown in step 58. The present embodiment uses the hypertext protocol (http) and the file transfer protocol (ftp) to interconnect and to exchange data. The feed engine 10 and the vendor servers 4, 5, 6 can use any number of data transfer formats to exchange data, such as text, CSV, JSON, and XML. The present embodiment uses comma- or tab-delimited text files to exchange data. The feed_config column 20 is used to determine the specific configuration for each vendor. In step 59, each feed file is processed to apply formatting, normalize commodity data, detect errors, etc., and then in step 60 the data is added (or updated) to the commodities database 13. Each time a successful update occurs, the update (including the date) is recorded by step 61 in the vendors database 12.

The feed engine can be configured to perform periodic updates with any frequency desired. The present embodiment is a “polling” environment which runs once daily. Updating too frequently may put a strain on available computer resources (processing and network bandwidth), whereas updating too infrequently may make the commodity data in 13 outdated. An improvement is a “push” environment, wherein the vendor servers 4, 5, and 6 are configured to automatically send updates to feed engine 10 whenever new or updated commodity information is available. “Push” vs. “poll” client/server configurations are well-known in the field, and the general concepts can be applied to the present invention. The feed engine 10 and the vendor servers 4, 5, 6 can use any number of protocols to connect, and to exchange data.

FIG. 9. shows an exemplary flow chart for the operation of ranking engine 11. From time to time, vendor agents 7, 8, and 9 access their branded commodity program record through the ranking engine 11 (such, as for example, row 48), and make updates to their bidding information, branded commodity program icon and other logos, and other related information (step 62), which is then recorded onto the branded commodity program database 14 (step 63). The ranking engine 11 then compares the bid column 47 of all applicable branded commodity programs, and reconfigures the tier & rank column 45 responsive to said bid information (step 63′). In the present embodiment, the branded commodity programs with the higher bids receive the more favorable tier & rank, which are then reflected on the search request form 64 displayed on the user client 1. In order to reduce constant churning of programs and therefore arising confusion on behalf of the user, the present embodiment requires that the operator of the server 2 manually approve all bids, before tier & rank values are changed. However, it will be understood by those skilled in the art that there are other obvious ways to reduce user confusion and chaos arising from rapid bidding.

The following description of FIGS. 14-15 is intended to provide an overview of computer hardware and other operating components suitable for performing the methods of the invention, but is not intended to limit the many applicable environments as described above. Similarly, the computer hardware and other operating components may be suitable as part of the systems of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 14 shows several computer systems 182 that are coupled together through a network 184, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 184 is typically provided by Internet service providers (ISP), such as the ISPs 186 and 188. Users on client systems, such as client computer systems 194, 198, 202, and 206 obtain access to the Internet through the Internet service providers, such as ISPs 186 and 188. Access to the Internet allows users of the client computer systems to exchange information, receive and send e-mails, and view documents, such as documents which have been prepared in the HTML format. These documents are often provided by web servers, such as web server 190 which is considered to be “on” the Internet. Often these web servers are provided by the ISPs, such as ISP 186, although a computer system can be set up and connected to the Internet without that system also being an ISP.

The web server 190 is typically at least one computer system which operates as a server computer system and is configured to operate with the protocols of the World Wide Web and is coupled to the Internet. Optionally, the web server 190 can be part of an ISP which provides access to the Internet for client systems. The web server 190 is shown coupled to the server computer system 192 which itself is coupled to web content 218, which can be considered a form of a media database. While two computer systems 190 and 192 are shown in FIG. 14, the web server system 190 and the server computer system 192 can be one computer system having different software components providing the web server functionality and the server functionality provided by the server computer system 192 which will be described further below.

Client computer systems 194, 198, 202, and 206 can each, with the appropriate web browsing software, view HTML pages provided by the web server 190. The ISP 186 provides Internet connectivity to the client computer system 194 through the modem interface 196 which can be considered part of the client computer system 194. The client computer system can be a personal computer system, a network computer, a Web TV system, a wireless PDA or cellular phone or automobile navigation console, or other such computer system.

Similarly, the ISP 188 provides Internet connectivity for client systems 198, 202, and 206, although as shown in FIG. 14, the connections are not the same for these three computer systems. Client computer system 198 is coupled through a modem interface 200 while client computer systems 202 and 206 are part of a LAN. While FIG. 14 shows the interfaces 196 and 200 as generically as a “modem,” each of these interfaces can be an analog modem, ISDN modem, cable modem, satellite transmission interface (e.g. “Direct PC”), urban wireless connectivity (e.g., cellular telephony), peer-to-peer interface (e.g. 802.11 and Bluetooth), or other interfaces for coupling a computer system to other computer systems.

Client computer systems 202 and 206 are coupled to a LAN 210 through network interfaces 204 and 208, which can be Ethernet network or other network interfaces. The LAN 210 is also coupled to a gateway computer system 220 which can provide firewall and other Internet related services for the local area network. This gateway computer system 220 is coupled to the ISP 188 to provide Internet connectivity to the client computer systems 202 and 206. The gateway computer system 220 can be a conventional server computer system. Also, the web server system 190 can be a conventional server computer system.

Alternatively, a server computer system 212 can be directly coupled to the LAN 210 through a network interface 214 to provide files 216 and other services to the clients 202, 206, without the need to connect to the Internet through the gateway system 220.

FIG. 15 shows one example of a conventional computer system 222 that can be used as a client computer system, a server computer system, a web server system, a client portable computer system (e.g. PDA or cellular phone or automobile navigation console), a component of a smart advertising display as previously described, etc. Such a computer system 222 can be used to perform many of the functions of an Internet service provider, such as ISP 186. The computer system 222 interfaces to external systems through the modem or network interface 226. It will be appreciated that the modem or network interface 226 can be considered as the delivery channels 50 (as shown in FIG. 1) and to be part of the computer system 222. This interface 226 can be an analog modem, ISDN modem, cable modem, token ring interface, satellite transmission interface (e.g. “Direct PC”), urban wireless connectivity (e.g., cellular telephony), peer-to-peer interface (e.g., 802.11 and Bluetooth), or other interfaces for coupling a computer system to other computer systems.

The computer system 222 includes a processor 224, which can be a conventional microprocessor such as an Intel® Pentium® microprocessor or Motorola® PowerPC® microprocessor. Memory 232 is coupled to the processor 224 by a bus 242. Memory 232 can be dynamic random access memory (DRAM) and can also include static RAM (SRAM). The bus 242 couples the processor 224 to the memory 232, to display controller 228, and to the input/output (I/O) controller 238.

The interface display controller 228 controls in the conventional manner a display on a display device 230 which can be a cathode ray tube (CRT) or liquid crystal display (LCD). The input/output devices 236 can include a keyboard, disk drives, printers, a scanner, and other input and output devices, including a mouse or other pointing device. The display controller 228 and the I/O controller 238 can be implemented with conventional well known technology. A digital image input device 240 can be a digital camera which is coupled to an I/O controller 238 in order to allow images from the digital camera to be input into the computer system 222.

One of skill in the art will immediately recognize that the terms “machine readable medium” or “computer-readable medium” includes any type of storage device that is accessible by the processor 224 and also encompasses a carrier wave that encodes a data signal.

The computer system 222 is one example of many possible computer systems which have different architectures. For example, personal computers based on an Intel microprocessor often have multiple buses, one of which can be an input/output (I/O) bus for the peripherals and one that directly connects the processor 224 and the memory 232 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 232 for execution by the processor 224. A Web TV system, which is known in the art, is also considered to be a computer system according to the present invention, but it may lack some of the features shown in FIG. 14, such as certain input or output devices. A typical computer system will usually include at least a processor, memory, and a bus coupling the memory to the processor.

In addition, the computer system 222 is controlled by operating system software which includes a file management system, such as a disk operating system, which is part of the operating system software. One example of an operating system software with its associated file management system software is the family of operating systems known as Windows® from Microsoft® Corporation of Redmond, Wash., and their associated file management systems. Another example of an operating system software with its associated file management system software is the LINUX® operating system and its associated file management system. The file management system is typically stored in the memory 232 and causes the processor 224 to execute the various acts required by the operating system to input and output data and to store data in memory.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

The systems described in FIGS. 14-15 are therefore capable of enabling the methods described herein regarding the server 2, the user client 1, and the vendor server 4, 5, and 6, and the features provided to allow users to interface with the system. One skilled in the art will appreciate that although specific embodiments of the present system and methods have been described for purposes of illustration, various modifications can be made without deviating from the scope or spirit of the present invention. Accordingly, the invention is described by the appended claims.

1. A computer-controlled method implemented in a multi-vendor commodity search engine server comprising:
receiving a search request, said search request responsive to input from a user into a multi-vendor commodity search engine input form, and said search request containing at least one instruction for filtering or sorting by at least one branded commodity;
executing said search request, said server searching a commodities database and filtering or sorting by the at least one branded commodity; and
transmitting a search result, said search result responsive to said search request, and containing information relating to at least one branded commodity.

2. the method in claim 1, further comprising: associating the at least one branded commodity with information from one of: a branded commodity programs database, and a vendors database.

3. the method in claim 1, further comprising:
receiving a first feed file from a first vendor server; and
adding data from said first feed file into said commodities database.

4. the method in claim 3, further comprising:
receiving a second feed file from a second vendor server; and
adding data from said second feed file into said commodities database.

5. the method in claim 4, wherein said commodity is a gemstone, and further wherein said information relating to the at least one branded gemstone includes one of: shape, carat weight, color, clarity, cut, depth percentage, table percentage, lab, fluorescence, symmetry, polish rating, girdle characteristics, culet characteristics, diamond measurements, price, and vendor.

6. the method in claim 1, further comprising:
receiving an initialization request, said request responsive to a request from a user to begin using said server; and
transmitting an initialization sequence responsive to said initialization request, said sequence containing configuration information for branded commodity program filters to display to the user within said multi-vendor commodity search engine input form.

7. the method in claim 6, wherein said configuration information includes at least one of:
tier, rank, name, and graphical information.

8. the method in claim 6, wherein said configuration information is stored in a branded commodity programs database.

9. the method in claim 1, wherein said commodity is a gemstone, and further wherein said information relating to the at least one branded gemstone includes one of: shape, carat weight, color, clarity, cut, depth percentage, table percentage, lab, fluorescence, symmetry, polish rating, girdle characteristics, culet characteristics, diamond measurements, price, vendor, and branded commodity icon.

10. A multi-vendor commodity search engine server comprising:
an interface for receiving a search request, said search request responsive to input from a user into a multi-vendor commodity search engine input form and said search request containing at least one instruction for filtering or sorting by at least one branded commodity, and for transmitting a search result, said search result responsive to said search request and containing information to at least one branded commodity; and,
a search engine for executing said search request and creating said search result, said search engine searching a commodities database and filtering or sorting by the at least one branded commodity.

11. The multi-vendor commodity search engine server as recited in claim 10, further wherein said search engine is configured to associate the at least one branded commodity with information from one of: a branded commodity programs database, and a vendors database.

12. The multi-vendor commodity search engine server as recited in claim 10, further comprising a feed engine for receiving a first feed file from a first vendor server, and for adding data from said first feed file into said commodities database.

13. The multi-vendor commodity search engine server as recited in claim 12, further wherein said feed engine is configured to receive a second feed file from a second vendor server, and is configured to add data from said second feed file into said commodities database.

14. The multi-vendor commodity search engine server as recited in claim 13, wherein said commodity is a gemstone, and further wherein said information relating to the at least one branded gemstone includes one of: shape, carat weight, color, clarity, cut, depth percentage, table percentage, lab, fluorescence, symmetry, polish rating, girdle characteristics, culet characteristics, diamond measurements, price, and vendor.

15. The multi-vendor commodity search engine server as recited in claim 10, further wherein said interface is configured to receive an initialization request, said request responsive to a request from a user to begin using said server, and said interface is further configured to transmit an initialization sequence responsive to said initialization request, said sequence containing configuration information for branded commodity program filters to display to the user within said multi-vendor commodity search engine input form.

16. The multi-vendor commodity search engine server as recited in claim 15, wherein said configuration information includes at least one of: tier, rank, name, and graphical information.

17. The multi-vendor commodity search engine server as recited in claim 15, wherein said configuration information is stored in a branded commodity programs database.

18. The multi-vendor commodity search engine server as recited in claim 10, wherein said commodity is a gemstone, and further wherein said information relating to the at least one branded gemstone includes one of: shape, carat weight, color, clarity, cut, depth percentage, table percentage, lab, fluorescence, symmetry, polish rating, girdle characteristics, culet characteristics, diamond measurements, price, vendor, and branded commodity icon.
